(19) United States
(12) Patent Application Publication
(10) Pub. No.: US 2003/0210952 A1
(43) Pub. Date: Nov. 13, 2003

(54) Joint

(76) Inventor: Po-Wen Hsiao, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/142,968

(22) Filed: May 13, 2002

(51) Int. Cl. B25G 3/18; F16B 21/00

(52) U.S. Cl. 403/322.4

(57) ABSTRACT

A joint includes a first link, a second link pivotally connected with the first link and a retainer for keeping the first and second links in any angular position relative to each other. The first link may include an engagement portion extending from a side thereof. The second link may include an engagement portion extending from a side thereof for engagement with the engagement portion of the first link. The engagement portion of the first link may be a semi-cylinder. The engagement portion of the second link may be a semi-cylinder. The engagement portion of the first link may define a slot. The engagement portion of the second link may define a hole. The retainer may include a shaft inserted in the slot defined in the first link and the hole defined in the second link. The first link may include a latch extending from the engagement portion thereof. The second link may define a recess for receiving the latch of the first link. The second link may include a latch extending from the engagement portion thereof. The first link may define a recess for receiving the latch of the second link. The first link may include an insert for insertion in a tube. The second link may include an insert for insertion in a tube. The retainer may be a quick-release device.

### BACKGROUND OF INVENTION

1. Field of Invention

The present invention relates to a joint.

2. Related Prior Art

Taiwanese Patent Publication No. 463886 teaches a joint 20 for connecting a rod 24 with a second rod 26. The joint includes a plate 30 extending from the first rod 24 and two plates 42 extending from the second rod 26. The plate 30 can be located between the plates 42. The plate 30 defines three apertures 32, 34 and 36. Each of the plates 42 defines two apertures 43 and 44. A shaft 46 is inserted in the apertures 32 and 44 so as to pivotally connect the first rod 24 with the second rod 26. Each of the plates 42 is equipped with a retainer 50. The retainer 50 includes a lever 52 pivotally mounted on the plate 42, a latch 54 linked to an end of the lever 52 and inserted through the aperture 43 and a spring 56 connected between an opposite end of the lever 52 and the plate 42. The latch 54 can be inserted in the aperture 34 or 35 thus retaining the rods 24 and 26 in a relative position or another. However, the positions of the apertures 34 and 36 limit the positions of the first rod 24 relative to the second rod 26. Moreover, this conventional joint is complicated in structure due to the large amount of elements. This entails a high cost and increases the possibility of malfunctioning. In addition, implemented in thin rods, the plates 30 and 42 may fail in provision of sufficient strength.

The present invention is therefore intended to obviate or at least alleviate the problems encountered in prior art.

### SUMMARY OF INVENTION

It is an objective of the present invention to provide a joint capable of retaining a rod in more than two positions relative to another rod.

It is another objective of the present invention to provide a joint simple in structure.

It is another objective of the present invention to provide a joint capable of providing a sufficient strength when it is implemented in thin rods.

According to the present invention, a joint includes a first link, a second link pivotally connected with the first link and a retainer for keeping the first and second links in any angular position relative to each other.

The first link may include an engagement portion extending from a side thereof. The second link may include an engagement portion extending from a side thereof for engagement with the engagement portion of the first link.

The engagement portion of the first link may be a semi-cylinder.

The engagement portion of the second link may be a semi-cylinder.

The engagement portion of the first link may define a slot. The engagement portion of the second link may define a hole. The retainer may include a shaft inserted in the slot defined in the first link and the hole defined in the second link.

The first link may include a latch extending from the engagement portion thereof. The second link may define a recess for receiving the latch of the first link.

The second link may include a latch extending from the engagement portion thereof. The first link may define a recess for receiving the latch of the second link.

The first link may include an insert for insertion in a tube.

The second link may include an insert for insertion in a tube.

The retainer may be a quick-release device.

Other objects, advantages, and novel features of the invention will become more apparent from the following detailed description when taken in conjunction with the attached drawings.

### BRIEF DESCRIPTION OF DRAWINGS

The present invention will be described through detailed illustration of the preferred embodiment referring to the attached drawings wherein:

FIG. 1 is a perspective view of a joint according to the present invention;

FIG. 2 is an exploded view of the joint shown in FIG. 1;

FIG. 3 is a cross-sectional view taken along a line 3-3 in FIG. 1;

FIG. 4 is a cross-sectional view taken along a line 4-4 in FIG. 1;

FIG. 5 is similar to FIG. 3 except for showing a lever in another position; and

FIG. 6 is similar to FIG. 4 except for showing two rods in another position relative to each other.

### DETAILED DESCRIPTION OF EMBODIMENTS

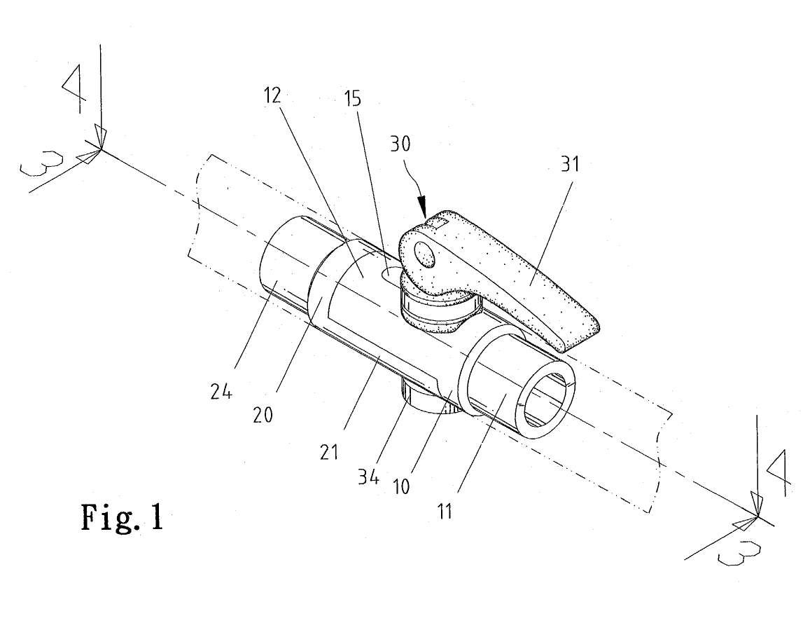

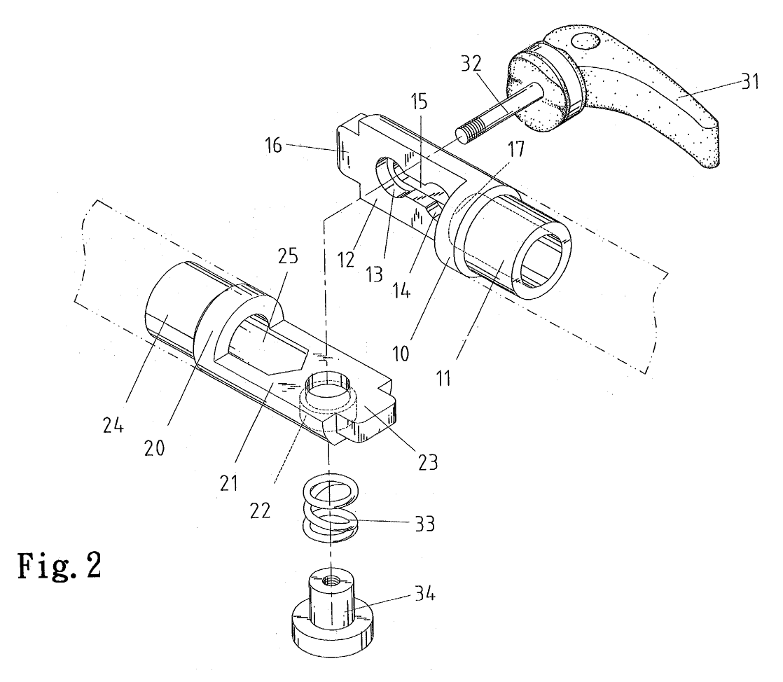

Referring to FIGS. 1 and 2, a joint according to the present invention includes links 10 and 20 that are pivotally connected with each other. The links 10 and 20 can be retained in position by means of a retainer 30.

The link 10 includes a disk (not numbered), an insert 11 extending from a side of the disk and a semi-cylinder 12 extending from another side of the disk. The insert 11 can be fitted in a tube as shown in phantom lines. The semi-cylinder 12 defines two holes 13 and 14 in communication with each other by means of a slot 15 defined therein. A latch 16 extends from the semi-cylinder 12. The disk of the link 10 is thick in order to define a recess 17.

The link 20 includes a disk (not numbered), an insert 24 extending from a side of the disk and a semi-cylinder 21 extending from another side of the disk. The insert 24 can be fitted in another tube as shown in phantom lines. The semi-cylinder 21 defines a counter-sink hole 22. A latch 23 extends from the semi-cylinder 21. The disk of the second link is thick in order to define a recess 25.

The retainer 30 includes a lever 31, a shaft 32, a spring 33 and a nut 34. The retainer 30 is a conventional quick-release device and will not be described in detail.

In assembly, the semi-cylinders 12 and 21 are engaged with each other. The shaft 32 is inserted through the hole 13 or 14. The spring 33 is received in the counter-sink hole 22. In the counter-sink hole 22, the nut 34 is engaged with the bolt 32.

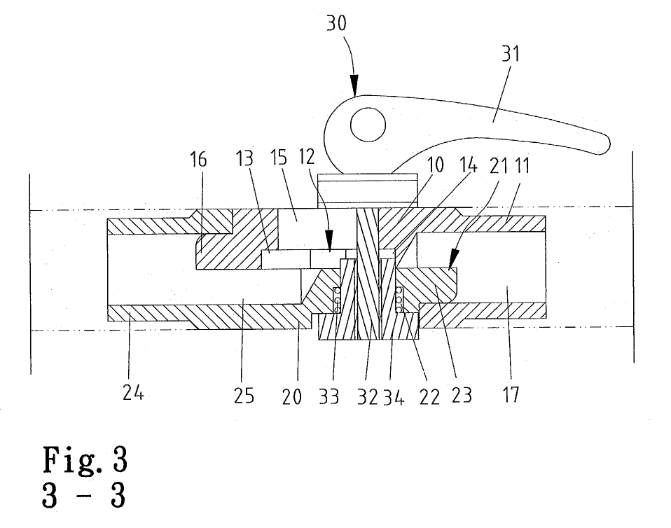

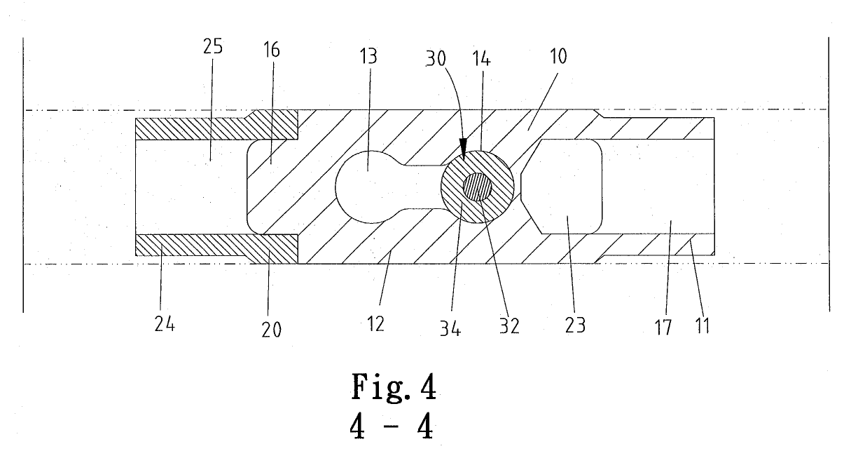

Referring to FIGS. 3 and 4, when a rectilinear arrangement of the tubes is desired, the latch 16 is inserted in the recess 25 and the latch 23 in the recess 17, thus avoiding the links 10 and 20 pivoting relative to each other. The shaft 32 is received in the hole 14. The lever 31 is in a first position where the semi-cylinders 12 and 21 are tightly pressed against each other by means of the retainer 30 thus keeping the latch 16 in the recess 25 and the latch 23 in the recess 17.

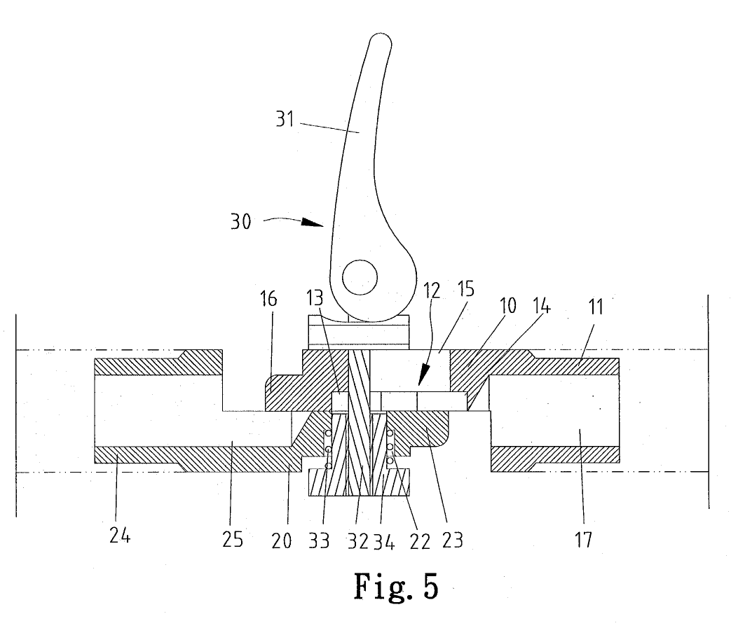

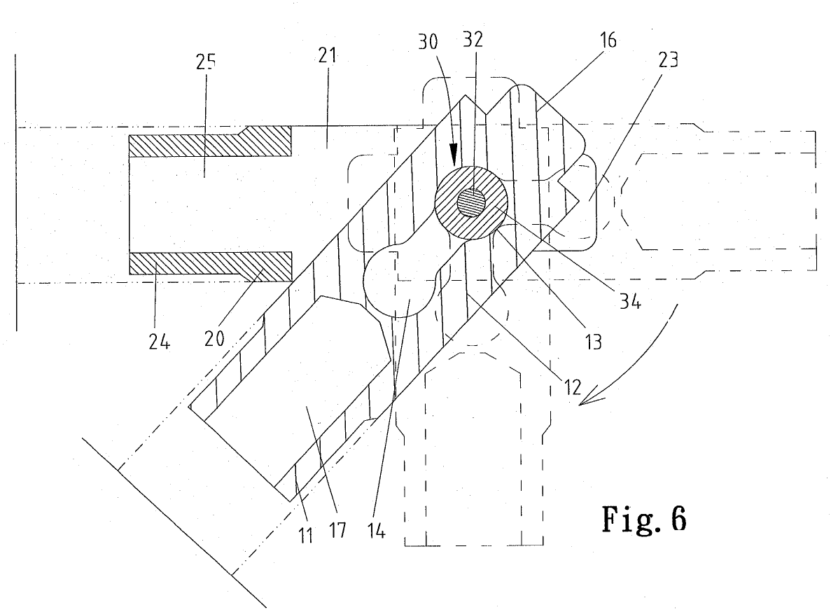

Referring to FIGS. 5 and 6, when an angular arrangement of the tubes is desired, the lever 31 is pivoted to a position where the semi-cylinders 12 and 21 are not pressed against each other by means of the retainer 30. The latch 16 is removed from the recess 25 and the latch 23 from the recess 17 while the shaft 32 is moved from the hole 14 to the hole 13 through the slot 15. Thus, the links 10 and 20 can be pivoted to any angular position relative to each other. The lever 31 can be pivoted back to the first position so that the links 10 and 20 are kept in the angular position relative to each other by means of the retainer 30.

The present invention has been described through detailed illustration of the preferred embodiment. Those skilled in the art can derive many variations from the preferred embodiment without departing from the scope of the present invention. Therefore, the preferred embodiment shall not limit the scope of the present invention. The scope of the present invention is defined in the attached claims.

1. A joint includes a first link (10), a second link (20) pivotally connected with the first link and a retainer (30) for keeping the first and second links (10, 20) in any angular position relative to each other.

2. The joint according to claim 1 wherein the first link (10) includes an engagement portion (12) extending from a side thereof and the second link (20) includes an engagement portion (21) extending from a side thereof for engagement with the engagement portion (12) of the first link (10).

3. The joint according to claim 2 wherein the engagement portion (12) of the first link (10) is a semi-cylinder.

4. The joint according to claim 2 wherein the engagement portion (21) of the second link (20) is a semi-cylinder.

5. The joint according to claim 2 wherein the engagement portion (12) of the first link (10) defines a slot (15) and the engagement portion (21) of the second link (20) defines a hole (22) and the retainer (30) includes a shaft (32) inserted in the slot (15) and the hole (22).

6. The joint according to claim 2 wherein the first link (10) includes a latch (16) extending from the engagement portion (12) thereof and the second link (20) defines a recess (25) for receiving the latch (16) of the first link (10).

7. The joint according to claim 2 wherein the second link (20) includes a latch (23) extending from the engagement portion (21) thereof and the first link (10) defines a recess (17) for receiving the latch (23) of the second link (20).

8. The joint according to claim 1 wherein the first link (10) includes an insert (11) for insertion in a tube.

9. The joint according to claim 1 wherein the second link (20) includes an insert (24) for insertion in a tube.

10. The joint according to claim 1 wherein the retainer (30) is a quick-release device.
